(19) United States
(12) Patent Application Publication
(10) Pub. No.: US 2010/0030462 A1
(43) Pub. Date: Feb. 4, 2010

(54) DISPLAY CONTROL APPARATUS, DISPLAY CONTROL METHOD, DISPLAY CONTROL PROGRAM, AND RECORDING MEDIUM

(75) Inventors: Hirobumi Iwaji, Hachiouji (JP); Tomohisa Tsukui, Tokorozawa (JP); Takeshi Matsuo, Kawagoe (JP); Masatoshi Ishinohachi, Kawagoe (JP); Eiji Ohta, Okegawa (JP); Masashi Aoyama, Ina (JP); Touko Aoki, Tsurugashima (JP)

Correspondence Address: YOUNG & THOMPSON, 209 Madison Street, Suite 500, Alexandria, VA, 22314, US

(73) Assignees: PIONEER CORPORATION, TOKYO (JP); PIONEER SYSTEM TECHNOLOGIES CORPORATION, SENDAI-SHI, MIYAGI (JP); TECHEXPERTS INCORPORATION, TOKYO (JP)

(21) Appl. No.: 12/526,101

(22) PCT Filed: Feb. 15, 2007
(86) PCT No.: PCT/JP2007/052685

§ 371 Date: Aug. 6, 2009

(51) Int. Cl. G01C 21/26

(52) U.S. Cl. 701/201; 701/212; 701/208

(57) ABSTRACT

A display control apparatus includes a position acquiring unit that acquires position information concerning a current position of a mobile object; an extracting unit that extracts position information related to regions included on a road information sign; a calculating unit that, based on the position information concerning the current position of the mobile object and the position information related to the regions included on the road information sign, calculates distances to each of the regions from the current position of the mobile object; and a display control unit that sets, based on the distances calculated by the calculating unit, a display state for text indicating the regions included on the road information sign and displays, in the display state set and on a display screen, the road information sign having the text.

### TECHNICAL FIELD

The present invention relates to a display control apparatus, a display control method, a display control program, and a recording medium that alter the display of a road sign according to position relative to a current position. However, application of the present invention is not limited to the display control apparatus, the display control method, the display control program, and the recording medium above.

### BACKGROUND ART

Conventionally, a road information display control apparatus has been proposed that includes a road information display control apparatus that stores road signs or road guidance information coupled with map information and displays the information on a display apparatus when a given range in front of the vehicle corresponds to the stored information; a camera that captures images of road signs or road information signs in front of the vehicle; an image processing apparatus that analyzes the images captured; a camera image display apparatus capable of displaying images; and a comparing unit that compares the road signs or the road information signs that are stored in the road information display control apparatus and correspond to the positions of the road signs or the road information signs analyzed by the image processing apparatus with the road signs or the road information signs analyzed by the image processing apparatus (see, for example, Patent Document 1).

Patent Document 1: Japanese Patent Application Laid-Open Publication No. 2005-300342

### DISCLOSURE OF INVENTION

### Problem to be Solved by the Invention

However, with the technology according to Patent Document 1, although only images necessary to the driver, such as road information signs, are extracted from the images captured by the on-board camera and displayed, a problem arises in that if the driver is in an unfamiliar area, even by looking at the names indicated on road signs, the driver does not know the positional relationship between his current position and the destination, the distance, etc. Further, by proceeding by relying solely on road information signs without going through the trouble of setting road guidance, the driver often becomes disoriented.

### Means for Solving Problem

To solve the problems above and achieve an object, a display control apparatus according to the invention of claim 1 displays, on a display screen, a road information sign indicating regions. The display control apparatus includes a position acquiring unit that acquires position information concerning a current position of a mobile object; an extracting unit that extracts position information related to the regions included on the road information sign; and a display control unit that, based on the position information acquired by the position acquiring unit and concerning the current position of the mobile object, controls and displays on the display screen, the position information that is related to the regions and extracted by the extracting unit.

A display control method according to the invention of claim 11 is a method of displaying, on a display screen, a road information sign indicating regions. The display control method includes acquiring position information concerning a current position of a mobile object; extracting position information related to the regions included on the road information sign; and displaying on the display screen and based on the position information acquired by the position acquiring unit and concerning the current position of the mobile object, the position information that is related to the regions and extracted by the extracting unit.

A display control program according to the invention of claim 12 causes a computer to execute the display control method according to claim 11.

A computer-readable recording medium according to the invention of claim 13 stores therein the display control program according to claim 12.

### BRIEF DESCRIPTION OF DRAWINGS

FIG. 1 is a block diagram of a functional configuration of a display control apparatus according to an embodiment;

FIG. 2 is a flowchart of display control processing performed by the display control apparatus;

FIG. 3 is a block diagram of a navigation apparatus according to an example;

FIG. 4 is a flowchart of processing by the navigation apparatus;

FIG. 5 is a flowchart of one example of processing for setting a destination;

FIG. 6 is a schematic of one example of a display of altered font;

FIG. 7 is a schematic of one example of changing scale to display map information; and

FIG. 8 is a schematic of one example of notification to prompt a user to select a new destination.

### EXPLANATIONS OF LETTERS OR NUMERALS

100 display control apparatus
101 display unit
102 position acquiring unit
103 extracting unit
104 calculating unit
105 receiving unit
106 display control unit
107 setting unit
108 informing unit

### BEST MODE(S) FOR CARRYING OUT THE INVENTION

With reference to the accompanying drawings preferred embodiments of a display control apparatus, a display control method, a display control program, and recording medium according to the present invention will be explained.

### Embodiment

### Functional Configuration of Display Control Apparatus 100

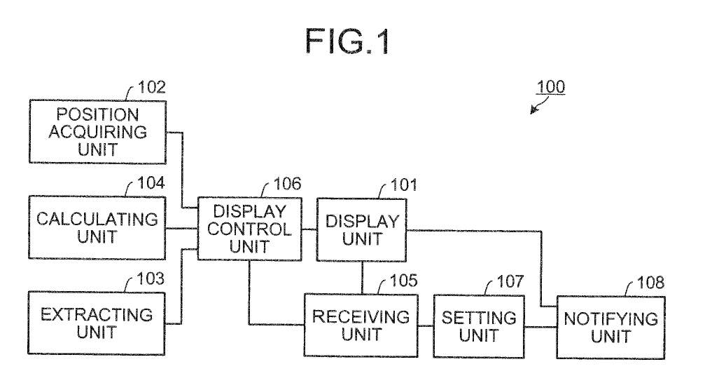

A functional configuration of a display control apparatus 100 according to an embodiment of the present invention will be explained. FIG. 1 is a block diagram of a functional configuration of the display control apparatus according to the present embodiment. The display control apparatus 100 displays on a display screen, road information signs indicating regions and the direction to each region.

As depicted in FIG. 1, the display control apparatus 100 includes a display unit 101, a position acquiring unit 102, an extracting unit 103, a calculating unit 104, a receiving unit 105, a display control unit 106, a setting unit 107, and a notifying unit 108. The display unit 101 includes a display screen that displays road information signs indicating regions and the direction to each region. Road information signs are, for example, signs that are provided at intersections and indicate to which region each of the roads at the intersection leads.

The display unit 101 may further display map information. Map information is stored in a storage unit, not depicted. Map information includes road network data formed by nodes and links, and image data drawn using features related to facilities, roads and other geographical features (mountains, rivers, land). Map information may further include information concerning road information signs, text information, information concerning facility names and addresses, and images of roads and facilities.

The position acquiring unit 102 acquires position information concerning the current position of a mobile object. Position information concerning the current position of the mobile object is acquired, for example, via a GPS unit, acceleration sensor, etc. equipped on a mobile object.

The extracting unit 103 extracts position information that is related to regions and the direction to each region included on road information signs. Position information that is related to regions included on road information signs, more specifically, for example, extracts information that indicates which regions (points) are on map information, such as text that indicates regions and is included on road information signs. The extracting unit 103 extracts, from information that is stored in the storage unit and related to road information signs, position information related to regions and may extract the position information related to regions from image information of the road information signs captured by the camera.

The calculating unit 104, based on the position information acquired by the position acquiring unit 102 and on position information related to regions and extracted by the extracting unit 103, calculates the distance from the current position of the mobile object to each region. Further, the calculating unit 104, based on the position information acquired by the position acquiring unit 102, calculates the distance from the current position of the mobile object to each base point indicated by the position information that is related to the regions and extracted by the extracting unit 103. A base point is a point of reference by which distance, time, etc. are measured. Specifically, a base point is, for example, a central point of a region displayed on a road information sign, a point or a structure representing the region, etc.

The receiving unit 105 receives selection of a region displayed on the display screen. For example, a selection is received through user operation of an input device. Specifically, selection is received when a touch panel embedded in the display screen is depressed.

The display control unit 106, based on the position information acquired by the position acquiring unit 102 and concerning the current position of the mobile object, controls and displays on the display screen, position information that is related to the regions and extracted by the extracting unit 103. For example, the display control unit 106, based on the distance calculated by the calculating unit 104, alters and displays text indicating the name of a region on a road information sign. Specifically, the shorter the distance calculated by the calculating unit 104, the more the display control unit 106 enlarges the size of the text. Further, the display control unit 106, based on the distance calculated by the calculating unit 104, changes the color of the text for display.

The display control unit 106 may change the scale of the map information for display, based on the distance between the current position of the mobile object indicated by position information acquired by the position acquiring unit 102 and the base point indicated by the position information concerning the region received by the receiving unit 105. Specifically, for example, the display control unit 106 displays map information of the area from the current position of the mobile object to the base point indicated by the position information concerning the region received by the receiving unit 105.

The setting unit 107 sets, as a destination, the base point indicated by the position information concerning the region received by the receiving unit 105. The mobile object is guided by a guiding unit, not depicted, to the destination set by the setting unit 107. Further, the setting unit 107 may temporarily set, as a destination, the base point indicated by the position information concerning the region received by the receiving unit 105. Specifically, for example, the setting unit 107 may set the base point as a waypoint. Further the setting unit 107 may set the base point, not as a waypoint, but as a travel direction.

The notifying unit 108 prompts the setting of a new destination from among regions displayed on the display screen, when the destination set (temporarily set) by the setting unit 107 is not included among the information on the road information sign. Information on the road information sign is information that indicates respectively the regions and the direction to each region included on each of the road information signs. The notifying unit 108, for example, prompts the user to set or temporarily set a new destination, when a destination, such as a waypoint or a travel direction, included on a road information sign displayed on the display screen and set temporarily by the setting unit 107 is not on the road information sign newly displayed on the display screen. Specifically, the notifying unit 108 displays text information on the display screen, such as “Enter a new destination”, outputs audio information, etc. Further, for example, the notifying unit 108 may cause a road information sign that does not include the destination temporarily set by the setting unit 107 as a waypoint or a travel direction, to flash.

### (Display Control Processing of Display Control Apparatus 100)

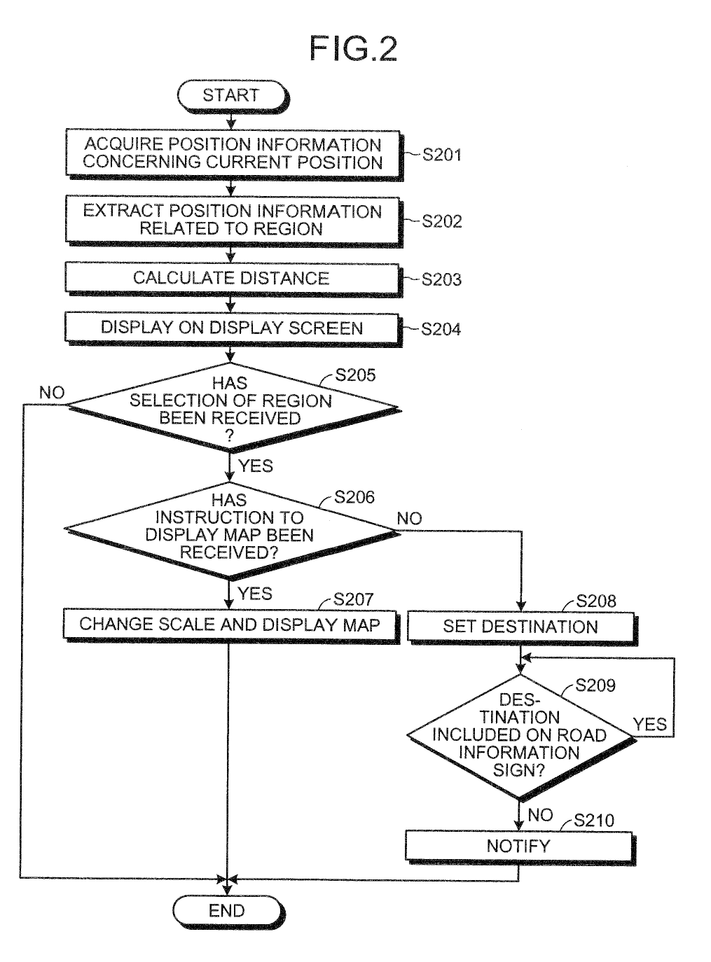

Display control processing of the display control apparatus 100 will be explained. FIG. 2 is a flowchart of display control processing performed by the display control apparatus 100. As depicted in FIG. 2, the position acquiring unit 102 acquires position information concerning the current position of the mobile object (step S201). The extracting unit 103 extracts position information related to regions included on a road information sign (step S202). At step S202, position information may be extracted from image information captured by the camera, from information stored in a storage unit not depicted, etc.

The calculating unit 104 calculates the distance from the current position of the mobile object to each region, based on the position information acquired at step S201 and the position information related to a region and extracted at step S202 (step S203). The display control unit 106 alters and displays on the display screen, text indicating regions included on a road information sign (step S204). At step S204, for example, the display control unit 106 alters, for display, the font of text indicating regions included on the road information sign. Further, the display control unit 106 may change the color of the text indicating regions included on the road information sign.

The receiving unit 105 determines whether selection of a region displayed on the display screen at step S204 has been received (step S205). At step S205, whether a region has been selected may be determined by a user input via the touch panel embedded in the display screen. At step S205, if selection of a region has not been received, (step S205: NO), a series of the processing ends.

On the other hand, at step S205, if selection of a region has been received (step S204: YES), the receiving unit 105 determines whether an instruction to display a map has been received from the user (step S206). At step S206, an instruction to display a map may be received when selection of a region is received at step S205: YES, before execution of the display control processing depicted in FIG. 2, etc.

If an instruction has been received at step S206 (step S206: YES), the display control unit 106 changes the scale of the map information for display, based on the distance between the current position of the mobile object indicated by position information acquired at step S201 and the base point indicated by the position information concerning the region received at step S205 (step S207), thereby ending a series of the processing.

At step S206, if an instruction to display a map is not received (step S206: NO), the setting unit 107 sets the base point indicated by the position information concerning the region received at step S205, as a destination (step S208). It is determined whether the destination set at step S208 is included on the road information sign (step S209). At step S209, for example, it may be determined whether the destination is included each time the road information sign is displayed on the display screen. The processing remains in standby as long as the destination is included on the road information sign at step S209 (step S209: YES). If the destination is not included on the road information sign (step S209: NO), the notifying unit 108 notifies the user (step S210), ending a series of the processing. At step S210, the user may be notified by, for example, a blinking of the road information sign on the display screen, output of audio information such as “Select a new destination”, text information, etc.

According to the flowchart depicted in FIG. 2, configuration is such that at step S204, text indicative of regions on a road information sign is altered for display and flow proceeds to step S205; however, configuration is not limited hereto. Specifically, for example, a series of the processing may end without proceeding to step S205. Further, for example, if flow proceeds to step S205, road information signs may be displayed at step S204 without alteration of the text.

Further, according to the flowchart depicted in FIG. 2, configuration is such that when selection of a region is not received at step S205: NO, a series of the processing ends; however, configuration is not limited hereto. Specifically, for example, a series of the processing may end if selection of a region is not received before the elapse of a given time period. Further, the user may be notified that selection of a region has not been received.

According to the flowchart depicted in FIG. 2, configuration is such that it is determined at step S209 whether the destination is included on the road information sign; however, configuration is not limited hereto. Specifically, for example, at step S208, if the base point is set, not as a waypoint or a travel direction, but as the destination of route guidance, configuration may be such that the mobile object is guided to the destination and a series of the processing ends.

As explained, according to the display control apparatus 100 of the present embodiment, based on the position information acquired by the position acquiring unit 102 and concerning the current position of the mobile object, position information related to a region and extracted by the extracting unit 103 can be controlled and displayed on the display screen by the display control unit 106. Thus, when a road information sign is displayed on the display screen, the current position can be displayed with respect to each region included on the road information sign. Consequently, even when in an unfamiliar region, the user knows the positional relationships between the current position, the destination, and the regions included on a road information sign, as well as corresponding distances and can easily grasp his current position.

According to the display control apparatus 100, based on the distance calculated by the calculating unit 104, text indicating the name of a region on a road information sign may be altered and displayed. Thus, the font of the text indicating a region on a road information sign displayed on the display screen may be altered according to the distance to the region from the current position. Consequently, the user knows the distance to each region from the current position and is able to grasp his current position.

Further, according to the display control apparatus 100, the shorter the distance calculated by the calculating unit 104, the greater the text is enlarged by the display control unit 106. Thus, the font of text indicating regions included on a road information sign displayed on the display screen may be progressively enlarged in descending order of distance and displayed. Consequently, the user knows the distance to each region from the current position and is able to grasp his current position.

According to the display control apparatus 100, based on the distance calculated by the calculating unit 104, the color of the text may be changed and displayed by the display control unit 106. Thus, the color of text indicating regions included on a road information sign displayed on the display screen may be changed according to the distance of the region relative to the current position. Consequently, even if the display screen, the display range, etc. is small, the user knows the distance to each region from the current position and is able to grasp his current position.

According to the display control apparatus 100, based on position information acquired by the acquiring unit 102 and concerning the current position of the mobile object, the calculating unit 103 can calculate the distances from the current position to the base points indicated by the position information related to regions and extracted by the extracting unit 103. Thus, the distance to a central point of a region included on a road information sign displayed on the display screen can be calculated. Consequently, even if the region included on a road information sign is large, the user is able to know the distance between his current position and a central point of the region, and thus, is able to precisely grasp his current position.

According to the display control apparatus 100, the scale of the map information can be changed for display, based on the distance between the current position of the mobile object indicated by position information acquired by the position acquiring unit 102 and the base point indicated by the position information concerning the region received by the receiving unit 105. Consequently, the user can find a better traveling route by selecting a region included on the road information sign displayed on the display screen and causing a map of the area from the current position to the destination to be displayed.

According to the display control apparatus 100, map information of the area between the current position of the vehicle and a base point indicated by position information of a region received by the receiving unit 105, can be displayed. Thus, a map that includes the base point indicated by position information of a region received by the receiving unit 105 and the current position of the vehicle can be displayed. Consequently, by the user selecting a region included on the road information sign displayed on the display screen and a display of a map of an area from the current position to the selected region, a better route from the current position can be found.

According to the display control apparatus 100, the setting unit 107 can set the base point indicated by the position information concerning the region received by the receiving unit 105. Thus, a destination for the route guidance can be set using a road information sign displayed on the display screen. Consequently, even if the user has preliminarily set a route, by using the road information sign, the user can simply perform route setting.

According to the display control apparatus 100, when the destination set by the setting unit 107 is not included in the information of the road information sign, the notifying unit 108 can prompt the setting of a new destination from among the regions displayed on the display screen. Thus, for example, if the setting unit 107 temporarily sets a destination and the destination is not on the road information sign displayed on the display screen, the user can be prompted to select a new destination.

### Example

An example of the present invention will be explained. The explained example is an example of the display control apparatus according to the present invention being implemented by a navigation apparatus equipped on a mobile object, such as a vehicle (including two- and four-wheel vehicles).

### (Hardware Configuration of Navigation Apparatus)

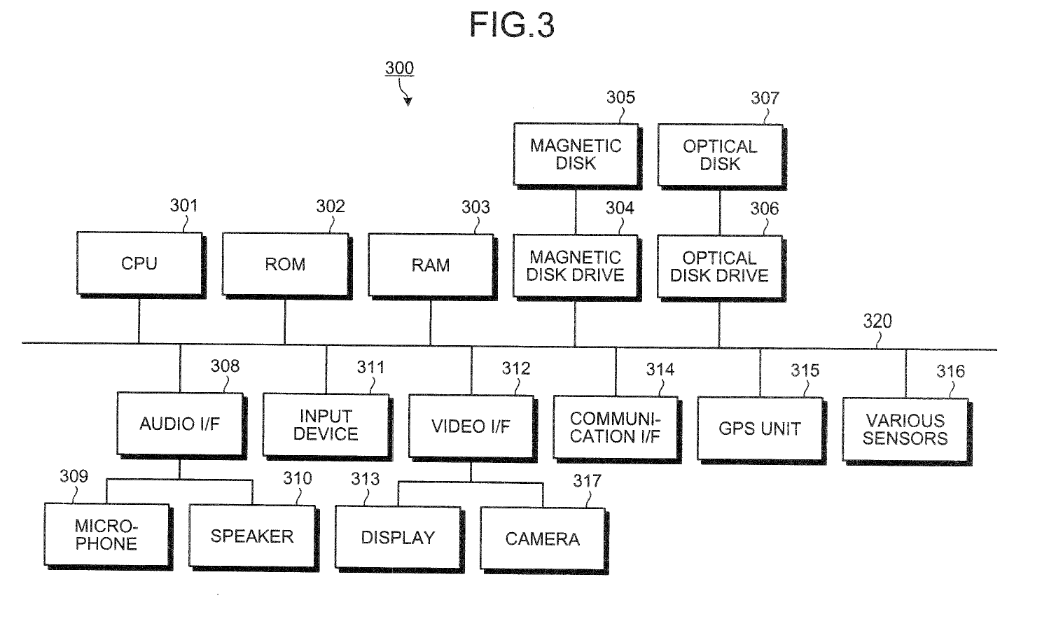

A hardware configuration of a navigation apparatus 300 according to the example will be explained. FIG. 3 is a block diagram of a navigation apparatus according to the example. As depicted in FIG. 3, the navigation apparatus 300 includes a CPU 301, a ROM 302, a RAM 303, a magnetic disk drive 304, a magnetic disk 305, an optical disk drive 306, an optical disk 307, an audio I/F (interface) 308, a microphone 309, a speaker 310, an input device 311, a video I/F 312, a display 313, a communication I/F (interface) 314, a GPS unit 315, various sensors 316, and a camera 317, respectively connected through a bus 320.

The CPU 301 governs overall control of the navigation apparatus 300. The ROM 302 stores therein various programs such as a boot program, a data updating program, a road sign recognition program, a region extracting program, etc. The RAM 303 is used a work area of the CPU 301, i.e., the CPU 301, while using the RAM 303 as a work area, executes various programs stored in the ROM 302 to govern overall control of the navigation apparatus 300.

The road sign recognition program recognizes road information signs in image data captured by the camera 317, and based on the current position of the vehicle, recognizes an arbitrary road information sign from among information stored on the magnetic disk 305 and the optical disk 307. The road information sign indicates regions, prominent points, major points, direction, etc.

The region extracting program determines whether text included in a road information sign recognized by the road sign recognizing program indicates a region (the name of a region). Specifically, for example, the region extracting program makes the determination based on information stored on the magnetic disk 305 and the optical disk 307. If it is determined that a region is indicated, the base point indicated by the position information concerning the region is extracted from map information stored on the magnetic disk 305 and the optical disk 307.

The magnetic disk drive 304 controls the reading and the writing of data with respect to the magnetic disk 305 under the control of the CPU 301. The magnetic disk 305 records data written thereto under the control of the magnetic disk drive 304. As the magnetic disk 305, for example, an HD (hard disk), FD (flexible disk), etc. may be used.

The optical disk drive 306 controls the reading and the writing of the data with respect to the optical disk 307 under the control of the CPU 301. The optical disk 307 is a removable recording medium from which data is read under the control of the optical disk drive 306. The optical disk 307 may be a writable recording medium. As the removal recording medium, a medium other than the optical disk 307 may be employed, such as an MO and a memory card.

One example of information stored on the magnetic disk 305 and the optical disk 307 may be map information or functional information. Map information includes background data indicative of terrestrial objects (features) such as buildings, rivers and ground surfaces, and road-shape data indicative of the shapes of roads; the data being divided into data files according to region.

Road-shape data further includes traffic condition data. Traffic condition data includes, for example, information indicating, with respect to each node, whether a signal or pedestrian crossing exists, a highway entrance and/or exit exists, a junction exists, etc.; and with respect to each link, indicating a length (distance), road width, direction of traffic flow, road types (highways, toll roads, general roads, etc.).

Functional information includes various kinds of data, such as data for displaying structures three-dimensionally on a map, text data describing the structures and other non-map information. Map information and functional information are stored in blocks according to region or function. Specifically, for example, map information is stored in a state enabling the map information to be blocked according to region to depict a given region on a map displayed on the display screen. Further, for example, functional information is stored in a state enabling the functional information to be blocked according to function to implement one function.

The functional information, in addition to data for three-dimensional display and text data, is data for implementing a function such as program data for implementing route searches, calculations of required time, and route guidance. The map information and functional information are divided into data files by region and function, respectively.

One example of other information stored on the magnetic disk 305 and the optical disk 307 is information related to road information signs. Information related to road information signs is, for example, information indicating which road information signs are at each position on map information, and information related to regions included on the road information signs. Information related to a region is information indicating the range (point) a region occupies on map information and may further include position information concerning a region, information related to a base point indicated by position information of a region. Base points are respectively indicated by position information concerning each region and may be, for example, a central point of a range indicated by a region, a major point, a major structure, etc. representing a region.

The audio I/F 308 is connected with the microphone 309 for audio input and the speaker 310 for audio output. Sound received by the microphone 309 is subjected to A/D conversion at the audio I/F 308. The microphone 309 may be provided near a sun visor and in plural or singularly. The speaker 310 outputs sound subjected to A/D conversion at the audio I/F 308. Sound input through the microphone 309 may be recorded as audio data on the magnetic disk 305 or the optical disk 307.

The input device 311 may be, for example, a remote controller having keys used to input characters, numerical values, or various kinds of instructions, a keyboard, a mouse, or a touch panel. Further, the input device 311 may be implemented by any one, or more, of the remote controller, the keyboard, and the touch panel.

The video I/F 312 is connected to the display 313. The video I/F 312 is made up of, for example, a graphic controller that controls the display 313, a buffer memory such as VRAM (Video RAM) that temporarily stores immediately displayable image information, and a control IC that controls the display 313 based on image data output from the graphic controller.

The display 313 displays icons, a cursor, menus, windows, or various data such as text and images. Map information may be drawn on the display 313 two-dimensionally or 3-dimensionally. A mark representing the current position of the vehicle on which the navigation apparatus 300 is equipped may be displayed superimposed on the map information displayed on the display 313. The current position of the mobile object is calculated by the CPU 301. The display 313 may display a road information sign. A road information sign may be displayed superimposed on map information. A touch panel may be embedded in the display 313.

A CRT, a TFT liquid crystal display, a plasma display and so on may be employed as the display 313. The display 313 may be provided, for example, near the dashboard of the vehicle. The display 313 may be provided in plural on the vehicle, where in addition to a position near the dashboard, the display 313 may be further provided near the rear seat of the vehicle.

The communication I/F 314 is wirelessly connected to a network and functions as an interface between the navigation apparatus 300 and the CPU 301. Further, the communication I/F 314 is connected wirelessly to a communication network, such as the Internet, and functions as an interface between the CPU 301 and the communication network.

The network includes a LAN, a WAN, a public line network, a mobile telephone network and so on. Specifically, the communication I/F 314 is made up of, for example, an FM tuner, a VICS (Vehicle Information and Communication System)/beacon receiver, a radio navigation apparatus, and other navigation apparatuses, and acquires road traffic information concerning congestion and traffic regulations distributed from a VICS center. VICS is a registered trademark.

The GPS unit 315 receives signals from GPS satellites and outputs information indicating the position of the vehicle. The information output by the GPS unit 315 is used together with values output from various sensors, described hereinafter, in the calculation of the current position of the vehicle, by the CPU 301. Information indicative of current position includes, for example, information indicating one point on map information, such as latitude, longitude, altitude, etc.

The various sensors 316 include a vehicular speed sensor, an acceleration sensor, and an angular speed sensor that respectively output information used to determine the position and behavior of the vehicle. Values output from the various sensors 316 are used by the CPU 301 to compute the current position and measure changes in speed, direction, etc.

The camera 317 captures images inside and outside the vehicle. The images may be still images or moving images. For example, images taken by the camera 317 and capturing the behavior of passengers in the vehicle are output through the video I/F 312 to a recording medium such as the magnetic disk 305 and the optical disk 307. The camera 317 may have an infrared camera function and based on image information captured using the infrared camera function, distributions of surface temperatures of objects in the vehicle can be compared. Images output to the recording medium may be overwritten and stored.

Functions of the display unit 101, the position acquiring unit 102, the extracting unit 103, the calculating unit 104, the receiving unit 105, the display control unit 106, the setting unit 107, and the notifying unit 108 of the display control apparatus 100 depicted in FIG. 1 are implemented by the CPU 301, using programs and data recorded on the ROM 302, the RAM 303, the magnetic disk 305, and the optical disk 307 of the navigation apparatus 300 depicted in FIG. 3, to execute a given program and control the respective components of the navigation apparatus 300.

In other words, the navigation apparatus 300 according to the example is able to execute the functions of the display control apparatus 100 according to the processing depicted in FIG. 2 by executing a display control program stored on the ROM 302, i.e., a recording medium of the navigation apparatus 300.

### (Processing by Navigation Apparatus 300)

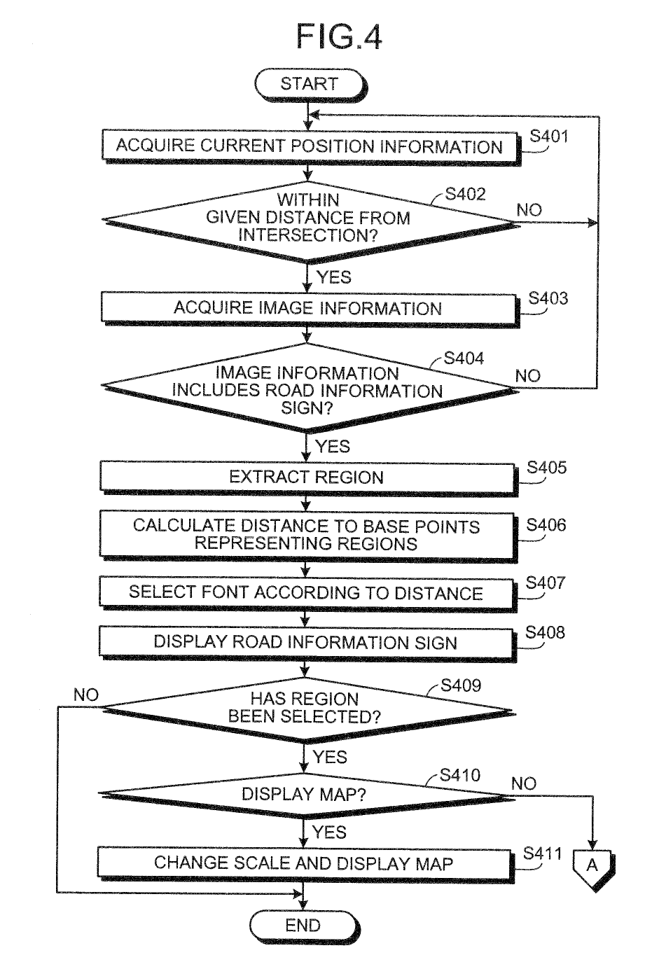

Processing by the navigation apparatus 300 will be explained. FIG. 4 is a flowchart of processing by the navigation apparatus. As depicted in the flowchart of FIG. 4, the GPS unit 315 acquires information concerning the current vehicle position (step S401). Based on map information stored on the magnetic disk 305 and the optical disk 307, it is determined whether the current vehicle position acquired at step S401 is within a given distance from an intersection (step S402).

If the current position is within a given distance from an intersection (step S402: YES), the camera 317 acquires image information of the vicinity near the intersection (step S403). At step S403, information related to a road information sign may be acquired from information stored on the magnetic disk 305 and the optical disk 307. Next, it is determined whether the image information acquired at step S403 includes a road information sign (step S404). Specifically, for example, the determination is made by the road sign recognition program.

If a road information sign is included at step S404 (step S404: YES), a region included on the road information sign is extracted (step S405). At step S405, position information of each region may be acquired and base points indicated by the position information of the regions may be extracted. Specifically, for example, extraction is performed by the region extracting program. The distances from the current vehicle position acquired at step S401 to base points extracted at step S405 and representing the regions is calculated (step S406). At step S406, a base point may be a central point of a region, a major station in a region, a structure representing the region, etc.

Font is selected according to the distances calculated at step S407 (step S408). Specifically, for example, font for indicating regions included on a road information sign may be progressively enlarged in descending order of the distances to the regions. Further, for example, the color of text for indicating regions may be selected according to the distances calculated at step S406.

The display of each of the regions is changed into the font selected at step S407 and the road Information sign is displayed (step S408). At step S408, the color of the text for indicating regions may be changed and the road information sign may be displayed. It is determined whether one region has been selected from among the regions included on the road information sign displayed at step S408 (step S409).

At step S409, if one region has been selected (step S409: YES), it is determined whether a map including the current vehicle position and the base point indicated by the position information of the region selected is to be displayed (step S410). At step S410, determination may be made through the receipt of an instruction input by the user. Specifically, for example, the user may preliminarily set the map to be displayed or at step S409, may select a region and further set the map to be displayed. At step S410, if a map is to be displayed (step S410: YES), the scale of a map inclusive of the current vehicle position and the base point of the position information indicated by the region selected is changed and the map is displayed (step S411), ending a series of the processing.

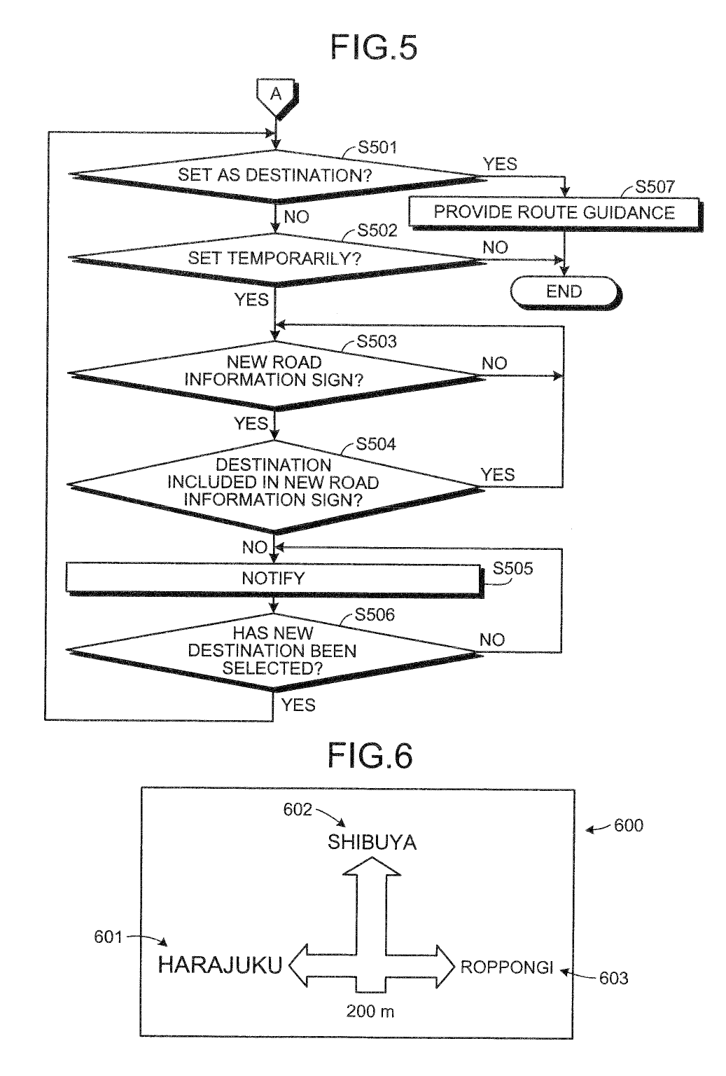

On the other hand, at step S402, if the current vehicle position is not within a given distance (step S402: NO) or at step S404, if the image information does not include a road information sign, flow returns to step S401 and a series of the processing is repeated. At step S409, if a region is not selected (step S409: NO), a series of the processing ends. Further, concerning a case where at step S410, it has been determined that a map is not to be displayed (step S140: NO), explanation will be given with reference to FIG. 5.

According to the flowchart of FIG. 4, at step S407, font is selected according to distance; however, configuration is not limited hereto. Specifically, for example, if processing from step S409 is to be performed, the selection of font according to distance may be omitted, in which case, at step S408, the road information sign may be displayed without changing the font or the color of the text.

Further, at step S408, a road information sign is displayed and at step S409, it is determined whether one region has been selected from among the regions included on the road information sign; however, configuration is not limited hereto. Specifically, for example, if at step S407, the font or the color of the text is selected according to distance and at step S408, the font or the color of the text is changed to that selected and the road information sign is displayed, a series of the processing may be ended here.

### (One Example of Processing for Setting Destination)

With reference to FIG. 5, processing will be described for setting a destination when, at step S410 depicted in FIG. 4, it is determined that a map is not to be displayed. FIG. 5 is a flowchart of one example of processing for setting a destination. As depicted in FIG. 5, it is determined whether the region selected at step S409 depicted in FIG. 4 is to be set as a destination (step S501). At step S501, if the region is not to be set as a destination (step S501: NO), it is determined whether the region selected at step S409 depicted in FIG. 4 is to be temporarily set as a destination (step S502).

At step S502, if the region is to be temporarily set as a destination (step S502: YES), it is determined whether image information acquired by the camera 317 includes a new road information sign (step S503). At step S503, if it is determined that there is a subsequent road information sign (step S503: YES), it is determined whether the destination temporarily set at step S502 is included on the new road information sign (step S504). If the destination temporarily set at step S504 is not included on the new road information sign (step S504: NO), the user is notified (step S505). At step S505, notification may be by causing the road information sign displayed to blink, by audio guidance, etc. Audio guidance may be, for example, guidance information such as “Select a new destination”. At step S503, if there is no new road information sign (step S503: NO), or at step S504, if the destination is included on the new road information sign (step S504: YES), flow returns to step S503 and a series of the processing is repeated.

Next, it is determined whether a new destination has been selected (steps S506). If a new destination has not been selected (step S506: NO), flow returns to step S505 and a series of the processing is repeated. At step S506, if a new destination has been selected (step S506: YES), flow returns to step S501 and a series of the processing is repeated. At step S501, if a region is set as a destination (step S501: YES), route guidance to the destination set at step S501 is performed (step S507), and a series of the processing ends. Further, at step S502, if the region is not temporarily set (step S502: NO), a series of the processing ends.

According to the flowchart of FIG. 5, at step S504, if the destination is included on the new road information sign (step S504: YES), waiting occurs until the destination is no longer included; however, configuration is not limited hereto. Specifically, for example, if the destination is included on the road information sign and the user has selected another region, the destination temporarily set may be changed to the newly selected region, in which case, flow returns to step S503 and a series of the processing is repeated.

According to the flowchart of FIG. 5, at step S506, if a new destination is not selected (step S506: NO), flow returns to step S505 and the user is notified until a new destination is selected; however, the configuration is not limited hereto. Specifically, for example, after a given number of notifications, a series of the processing may end.

### (Example of Alteration and Display of Font for Road Information Sign)

With reference to FIG. 6, one example of alteration and display of the font for a road information sign at step S408 depicted in FIG. 4 will be explained. FIG. 6 is a schematic of one example of a display of altered font. As depicted in FIG. 6, a road information sign 600 is displayed on the display 313. The road information sign 600 includes “Harajuku” 601, “Shibuya” 602, and “Roppongi” 603, as region information, and the direction to each region.

As depicted in FIG. 6, from the current vehicle position, “Harajuku” 601 is the nearest and is displayed in large-sized font; “Shibuya” 602 is the second nearest and is displayed in medium-sized font; and “Roppongi” 603 is the farthest and is displayed in small-sized font. Thus, alteration of the font based on the distance from the current vehicle position enables the user to easily grasp the positional relationship between the current vehicle position and each region displayed on the road information sign.

Although in FIG. 6, the font is depicted to be progressively enlarged in descending order of distance from the current vehicle position, configuration is not limited hereto. Specifically, for example, the color of the text may be changed based on the distance from the current vehicle position. For example, “Harajuku” 601, which is nearest the current vehicle position, may be displayed in red; the next nearest, “Shibuya”, 602 may be displayed in orange; and the farthest, “Roppongi”, 603 may be displayed in yellow. In such a case, the size of the font may be altered or may not be altered.

### (Example of Changing of Scale and Display of Map Information)

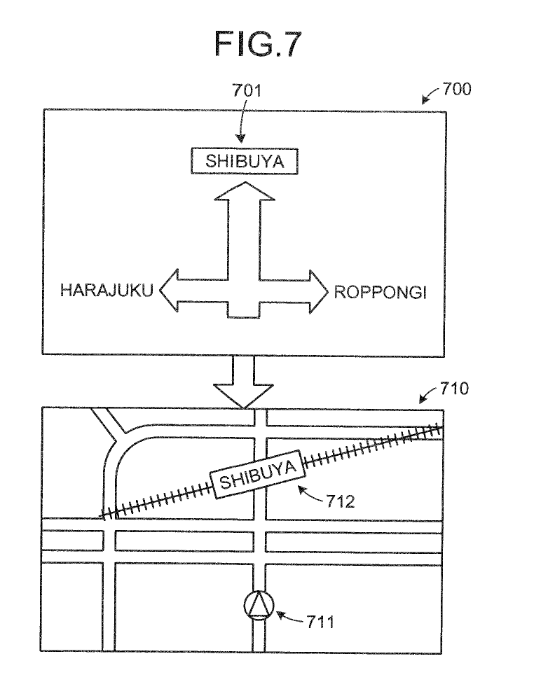

An example of changing scale to display map information at step S411 depicted in FIG. 4 will be explained. FIG. 7 is a schematic of one example of changing scale to display map information. FIG. 7 a result of a road information sign being displayed at step S411 depicted in FIG. 4 and a region being selected at step S409: YES. Specifically, for example, a road information sign 700 is displayed on the display 313 and “Shibuya” 701 has been selected.

If a map is to be displayed (step S410: YES), specifically, for example, a map 710, whose scale has been changed, is displayed that includes the current vehicle position 711 and a base point 712 indicated by “Shibuya” 701. Thus, by displaying a map including the current vehicle position and the base point 712, a better route to the selected region can be found.

According to the explanation with respect to FIG. 7, a map inclusive of the current vehicle position 711 and the base point 712 is displayed; however, configuration is not limited hereto. Specifically, for example, a map may be displayed that includes the current vehicle position 711 and the entire region selected.

### (Example of Notification to Prompt User to Select New Destination)

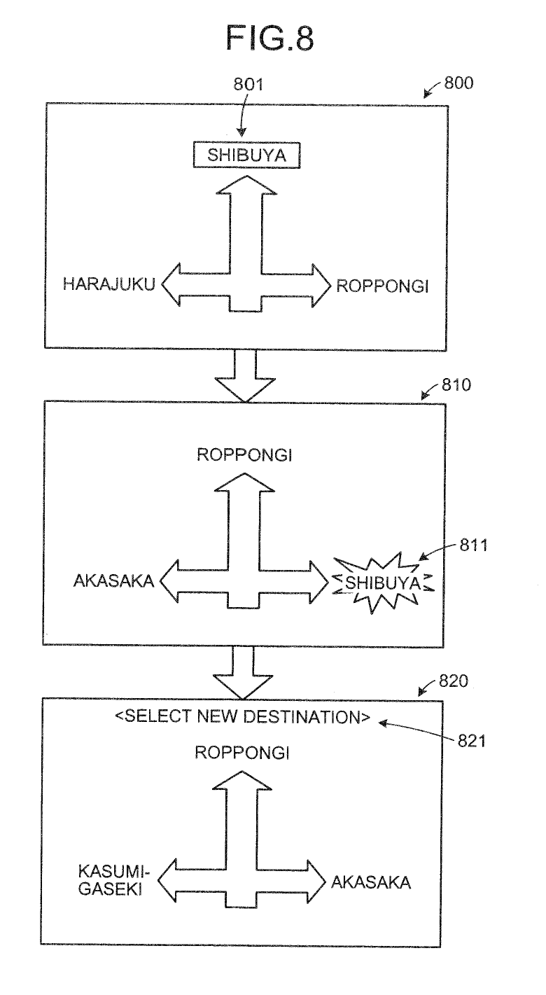

With reference to FIG. 8, one example of notification at step S505 depicted in FIG. 5 will be explained. FIG. 8 is a schematic of one example of notification to prompt the user to select a new destination. A destination is temporarily set (step S502: YES). As depicted in FIG. 8, for example, from the road information sign displayed on the display 313, “Shibuya” 801 is temporarily set as a destination. Subsequently, if there is a new road information sign 811 (step S503: YES depicted in FIG. 5), at step S504, it is determined whether the destination is included on the new road information sign 811. As depicted in FIG. 8, specifically, for example, it is determined whether “Shibuya” 801 is included on the new road information sign 810. If “Shibuya” 801 is included, waiting occurs until a new road information sign is acquired.

If the destination is not included on the new road information sign (step S504: NO depicted in FIG. 5), at step S505, the user is notified. Specifically, for example, if there is a new road information sign 820 that does not include “Shibuya” 801, the user is notified of information 821, such as “Select a new destination”, prompting the user to select a new destination. The user may be notified by audio information, a warning sound, or by causing the new road information sign 820, in which “Shibuya” 801 is not included, to blink.

As explained, according to the navigation apparatus 300 of the present example, based on the position information acquired by the position acquiring unit 102 and concerning the current position of the mobile object, position information related to a region and extracted by the extracting unit 103 can be controlled by the display control unit 106 and displayed on the display screen. Thus, when a road information sign is displayed on the display screen, the current position can be displayed with respect to each region included on the road information sign. Consequently, even when in an unfamiliar region, the user knows the positional relationships between the current position, the destination, and the regions included on a road information sign, as well as corresponding distances and can easily grasp his current position.

According to the navigation apparatus 300 of the present example, based on the distance calculated by the calculating unit 104, text indicating the name of a region on a road information sign may be altered and displayed. Thus, the font of the text indicating a region on a road information sign displayed on the display screen may be altered according to the distance to the region from the current position. Consequently, the user knows the distance to each region from the current position and is able to grasp his current position.

Further, according to the navigation apparatus 300 of the present example, the shorter the distance calculated by the calculating unit 104, the greater the text is enlarged by the display control unit 106. Thus, the font of text indicating regions included on a road information sign displayed on the display screen may be progressively enlarged in descending order of distance and displayed. Consequently, the user knows the distance to each region from the current position and is able to grasp his current position.

According to the navigation apparatus 300 of the present example, based on the distance calculated by the calculating unit 104, the color of the text may be changed and displayed by the display control unit 106. Thus, the color of text indicating regions included on a road information sign displayed on the display screen may be changed according to the distance of the region relative to the current position. Consequently, even if the display screen, the display range, etc. is small, the user knows the distance to each region from the current position and is able to grasp his current position.

According to the navigation apparatus 300 of the present example, based on position information acquired by the acquiring unit 102 and concerning the current position of the mobile object, the calculating unit 103 can calculate the distances from the current position to the base points indicated by the position information related to regions and extracted by the extracting unit 103. Thus, the distance between a central point of a region included on a road information sign displayed on the display screen can be calculated. Consequently, even if the region included on a road information sign is large, the user is able to know the distance between his current position and a central point of the region, and thus, is able to precisely grasp his current position.

According to the navigation apparatus 300 of the present example, the scale of the map information can be changed for display, based on the distance between the current position of the mobile object indicated by position information acquired by the position acquiring unit 102 and the base point indicated by the position information concerning the region received by the receiving unit 105. Consequently, the user can find a better traveling route by selecting a region included on the road information sign displayed on the display screen and causing a map of the area from the current position to the destination to be displayed.

According to the navigation apparatus 300 of the present example, map information of the area between the current position of the vehicle and a base point indicated by position information of a region received by the receiving unit 105, can be displayed. Thus, a map that includes the base point indicated by position information of a region received by the receiving unit 105 and the current position of the vehicle can be displayed. Consequently, by the user selecting a region included on the road information sign displayed on the display screen and a display of a map of an area from the current position to the selected region, a better route from the current position can be found.

According to the navigation apparatus 300 of the present example, the setting unit 107 can set the base point indicated by the position information concerning the region received by the receiving unit 105. Thus, a destination for the route guidance can be set using a road information sign displayed on the display screen. Consequently, even if the user has preliminarily set a route, by using the road information sign, the user can simply perform route setting.

According to the navigation apparatus 300 of the present example, when the destination set by the setting unit 107 is not included in the information of the road information sign, the notifying unit 108 can prompt the setting of a new destination from among the regions displayed on the display screen. Thus, for example, if the setting unit 107 temporarily sets a destination and the destination is not on the road information sign displayed on the display screen, the user can be prompted to select a new destination.

As explained, according to the display control apparatus, display control method, display control program, and recording medium of the present invention, in a navigation apparatus 300, based on the distance between the current vehicle position and a base point indicated by position information of a region included on a road information sign, the font and the color of text indicating the region included on the road information sign can be changed and displayed on the display 313. Further, receipt of a selection of a region included on a road information sign enables the display of a map and the setting of a destination. Consequently, the user knows his current position and can arrive assuredly at the destination with the same mindset as when he relies solely on the road information signs without the navigation apparatus 300.

The display control method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be distributed through a network such as the Internet.

1-13. (canceled)

14. A display control apparatus comprising:
a position acquiring unit that acquires position information concerning a current position of a mobile object;
an extracting unit that extracts position information related to regions included on a road information sign;
a calculating unit that, based on the position information concerning the current position of the mobile object and the position information related to the regions included on the road information sign, calculates distances to each of the regions from the current position of the mobile object; and
a display control unit that sets, based on the distances calculated by the calculating unit, a display state for text indicating the regions included on the road information sign and displays, in the display state set and on a display screen, the road information sign having the text.

15. The display control apparatus according to claim 14, wherein the display control unit, based on the distances calculated by the calculating unit, sets a size for the text.

16. The display control apparatus according to claim 14, wherein the display control unit, based on the distances calculated by the calculating unit, sets a color for the text.

17. A display control apparatus comprising;
a position acquiring unit that acquires position information concerning a current position of a mobile object;
an extracting unit that extracts position information related to regions included on a road information sign;
a display control unit that displays the road information sign on a display screen; and a receiving unit that receives selection of a region included on the road information sign displayed on the display screen, wherein the display control unit, based on the position information concerning the current position of the mobile object sets and the position information concerning the region received via the receiving unit, sets a scale and according to the scale set, displays map information on the display screen.

18. The display control apparatus according to claim 17, wherein the display control unit, based on a distance from the current position of the mobile object to a base point indicated by the position information concerning the region received via the receiving unit, sets the scale.

19. The display control apparatus according to claim 17, wherein the display control unit displays map information of an area from the current position of the mobile object to the base point indicated by the position information concerning the region received via the receiving unit.

20. A display control apparatus comprising:
an extracting unit that extracts position information related to regions included on a road information sign;
a display control unit that displays the road information sign on a display screen;
a receiving unit that receives selection of a region included on the road information sign displayed on the display screen; and a setting unit that sets, as a destination, a base point indicated by the position information concerning the region received via the receiving unit.

21. The display control apparatus according to claim 20 further comprising a notifying unit that, when the destination set by the setting unit is not included on a new road information sign, provides notification prompting a setting of a new destination from among regions displayed on the new road information sign.

22. A display control method comprising:
acquiring position information concerning a current position of a mobile object;
extracting position information related to regions included on a road information sign;
calculating, based on the position information concerning the current position of the mobile object and the position information related to the regions included on the road information sign, distances to each of the regions from the current position of the mobile object;
setting, based on the distances calculated at the calculating, a display state for text indicating the regions included on the road information sign; and displaying, in the display state set and on a display screen, the road information sign having the text.

23. A computer-readable recording medium storing therein a display control program causing a computer to execute the display program according to claim 22.
